(19) United States
(12) Patent Application Publication
(10) Pub. No.: US 2020/0082158 A1
(43) Pub. Date: Mar. 12, 2020

(54) FACIAL IMAGE MAKEUP TRANSFER SYSTEM

(71) Applicant: Algomus, Inc., Troy, MI (US)

(72) Inventors: Amjad Hussain, Bloomfield Hills, MI (US); Taleb Alashkar, Royal Oak, MI (US); Seyeddavar Daeinejad, Troy, MI (US)

(21) Appl. No.: 16/564,882

(22) Filed: Sep. 9, 2019

Related U.S. Application Data
(60) Provisional application No. 62/729,131, filed on Sep. 10, 2018.

(51) Int. Cl. G06K 9/00; G06T 7/11; G06T 11/60

(52) U.S. Cl. CPC G06K 9/00281; G06T 2207/20132; G06T 11/60; G06T 7/11

(57) ABSTRACT

A facial image makeup transfer system is provided. The system utilizes a computer that utilizes two images as input, one with the client whose facial makeup will be transferred (known as reference facial image) and the other with the client whose face will receive the makeup (known as the target facial image). The position of the two faces is determined and landmarks are generated around different facial components in both images. Thereafter, the face in the reference facial image is geometrically aligned such that its geometry fits that of the client face in the target facial image. Thereafter, the color values in the reference facial image are smoothly transferred to the corresponding ones in the target facial image in a pixel-wise fashion.

### CROSS-REFERENCE TO RELATED APPLICATIONS

This application claims priority to U.S. Provisional Patent Application No. 62/729,131 filed on Sep. 10, 2018, the entire contents of which are hereby incorporated by reference herein.

### BACKGROUND

The use of facial makeup is an ancient human practice, and plays an important role in human face appearance. Also, facial makeup alters face features to make a face look younger, sharper and more attractive by leveraging face symmetry. Also, facial makeup hides face flaws, wrinkles and aging cues.

One of the most common questions that beauty salons clients pose is “What is the makeup style to wear today?” Most beauty salons provide a catalog for the most trendy makeup styles that they show to the client to choose from. Many times, it is difficult to determine whether a makeup style on a makeup models face will look well on the face of a client.

Also, applying more than one makeup style on a client's face in the beauty salon is time consuming and costly. Further, if the applied makeup style does not look good on the client's face, they may not be satisfied with the beauty salons service.

The inventors herein have recognized that it would be advantageous to provide a system that allows a client to visually observe one or more images of their face with different makeup styles on their face from any makeup style model face—before having the makeup applied to the client's face. Further, such a system would ensure that the client is more satisfied with the final makeup application, and reduce the makeup style selection time, and reduce the cost by applying different makeup styles and consuming more products in the beauty salon.

### SUMMARY

A facial image makeup transfer system in accordance with an exemplary embodiment is provided. The facial image makeup transfer system includes a display device. The facial image makeup transfer system further includes a computer operably coupled to the display device. The computer has a color adjustment application, a conversion application, an image decomposition application, a lightness image decomposition application, a makeup transfer application, and an image summation application. The color adjustment application performs a linear color transformation of a reference facial skin image utilizing a linear color transformation equation to obtain a color-adjusted reference facial skin image. The conversion application converts the color-adjusted reference facial skin image from the first color space to a second color space. The conversion application converts a target facial skin image from the first color space to the second color space. The image decomposition application decomposes the color-adjusted reference facial skin image in the second color space into a first primary lightness channel image and first and second color channel images. The lightness image decomposition application decomposes the first primary lightness channel image into first and second lightness channel images. The image decomposition application decomposes the target facial skin image in the second color space into a second primary lightness channel image and third and fourth color channel images. The lightness image decomposition application decomposes the second primary lightness channel image into third and fourth lightness channel images. The makeup transfer application pixel-wise mixes the first and second lightness channel images of the color-adjusted reference facial skin image with the third and fourth lightness channel images of the target facial skin image, respectively, to obtain first and second mixed lightness channel images, respectively. The makeup transfer application pixel-wise mixes the first and second color channel images of the color-adjusted reference facial skin image with the third and fourth color channel images of the target facial skin image, respectively, to obtain first and second mixed color channel images, respectively. The image summation application sums the first and second mixed lightness channel images to obtain a first combined lightness channel image. The conversion application merges the first combined lightness channel image and the first and second mixed color channel images to obtain a resultant target facial skin image in the second color space and converts the resultant target facial skin image to the first color space.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic of a facial image makeup transfer system in accordance with an exemplary embodiment;

FIG. 2 is a block diagram of applications utilized by the facial image makeup transfer system of FIG. 1 including a landmark detection application, a face geometric alignment application, a color adjustment application, a conversion application, an image decomposition application, a lightness image decomposition application, a makeup transfer application, and an image summation application;

FIGS. 3-8 are flowcharts of a method for generating a final target facial image having a desired makeup thereon based on a reference facial image having the desired makeup thereon and a target facial image of a client, utilizing the facial image makeup transfer system of FIG. 1;

FIG. 9 is a reference facial image of a model in a first color space having desired makeup therein;

FIG. 10 is a target facial image of a client in the first color space;

FIG. 11 is a final target facial image of the client in the first color space having the desired makeup therein that is generated utilizing the reference facial image of FIG. 9 and the target facial image of FIG. 10;

FIG. 12 is another reference facial image in the first color space having desired makeup therein;

FIG. 13 is the reference facial image of FIG. 12 having a boundary box therein that defines a boundary of a face;

FIG. 14 is another target facial image in the first color space;

FIG. 15 is the target facial image of FIG. 14 having a boundary box therein that defines a boundary of a face;

FIG. 16 is the reference facial image of FIG. 12 having a plurality of landmarks therein that define the boundaries of facial features;

FIG. 17 is the target facial image of FIG. 14 having a plurality of landmarks therein that define the boundaries of facial features;

FIG. 18 is an aligned cropped reference facial image in the first color space that is generated from the reference facial image of FIG. 12;

FIG. 19 is a reference facial skin image in the first color space that is generated from the aligned cropped reference facial image of FIG. 18;

FIG. 20 is a reference lips image in the first color space that is generated from the aligned cropped reference facial image of FIG. 18;

FIG. 21 is cropped target facial image in the first color space that is generated from the target facial image of FIG. 14;

FIG. 22 is a target facial skin image in the first color space that is generated from the cropped target facial image of FIG. 21;

FIG. 23 is a target lips image in the first color space that is generated from the cropped target facial image of FIG. 21;

FIG. 24 is the reference facial skin image of FIG. 19;

FIG. 25 is the target facial skin image of FIG. 22;

FIG. 26 is a color-adjusted reference facial skin image in the first color space that is generated from the reference facial skin image of FIG. 24 and the target facial skin image of FIG. 25;

FIG. 27 is the color-adjusted reference facial skin image of FIG. 26 in the first color space;

FIG. 28 is a first primary lightness channel image in a second color space that is generated from the color-adjusted reference facial skin image of FIG. 27;

FIG. 29 is a first color channel image in the second color space that is generated from the color-adjusted reference facial skin image of FIG. 27;

FIG. 30 is a second color channel image in the second color space that is generated from the color-adjusted reference facial skin image of FIG. 27;

FIG. 31 is the target facial skin image of FIG. 25 in the first color space;

FIG. 32 is a second primary lightness channel image in the second color space that is generated from the target facial skin image of FIG. 31;

FIG. 33 is a third color channel image in the second color space that is generated from the target facial skin image of FIG. 31;

FIG. 34 is a fourth color channel image in the second color space that is generated from the target facial skin image of FIG. 31;

FIG. 35 is the first primary lightness channel image of FIG. 28;

FIG. 36 is a first lightness channel image in the second color space that is generated from the first primary lightness channel image of FIG. 35;

FIG. 37 is a second lightness channel image in the second color space that is generated from the first primary lightness channel image of FIG. 35;

FIG. 38 is the second primary lightness channel image of FIG. 32;

FIG. 39 is a third lightness channel image in the second color space that is generated from the second primary lightness channel image of FIG. 38;

FIG. 40 is a fourth lightness channel image in the second color space that is generated from the second primary lightness channel image of FIG. 38;

FIG. 41 is the reference lips image of FIG. 20 in the first color space;

FIG. 42 is a third primary lightness channel image in the second color space that is generated from the reference lips image of FIG. 41;

FIG. 43 is a fifth color channel image in the second color space that is generated from the reference lips image of FIG. 41;

FIG. 44 is a sixth color channel image in the second color space that is generated from the reference lips image of FIG. 41;

FIG. 45 is the target lips image of FIG. 23 and the first color space;

FIG. 46 is a fourth primary lightness channel image in the second color space that is generated from the target lips image of FIG. 45;

FIG. 47 is a seventh color channel image in the second color space that is generated from the target lips image of FIG. 45;

FIG. 48 is an eighth color channel image in the second color space that is generated from the target lips image of FIG. 45;

FIG. 49 is the third primary lightness channel image of FIG. 42 in the second color space;

FIG. 50 is a fifth lightness channel image in the second color space that is generated from the third primary lightness channel image of FIG. 49;

FIG. 51 is a sixth lightness channel image in the second color space that is generated from the third primary lightness channel image of FIG. 49;

FIG. 52 is the fourth primary lightness channel image of FIG. 46 in the second color space;

FIG. 53 is a seventh lightness channel image in the second color space that is generated from the fourth primary lightness channel image of FIG. 52;

FIG. 54 is an eighth lightness channel image in the second color space that is generated from the fourth primary lightness channel image of FIG. 52;

FIG. 55 is the reference facial image of FIG. 12;

FIG. 56 is the target facial image of FIG. 14;

FIG. 57 is a final target facial image having the desired makeup therein that is that is generated from the reference facial image of FIG. 55 and the target facial image of FIG. 56;

FIG. 58 is a cropped reference facial skin image in the first color space; and

FIG. 59 is a cropped target background and eyes image in the first color space.

### DETAILED DESCRIPTION

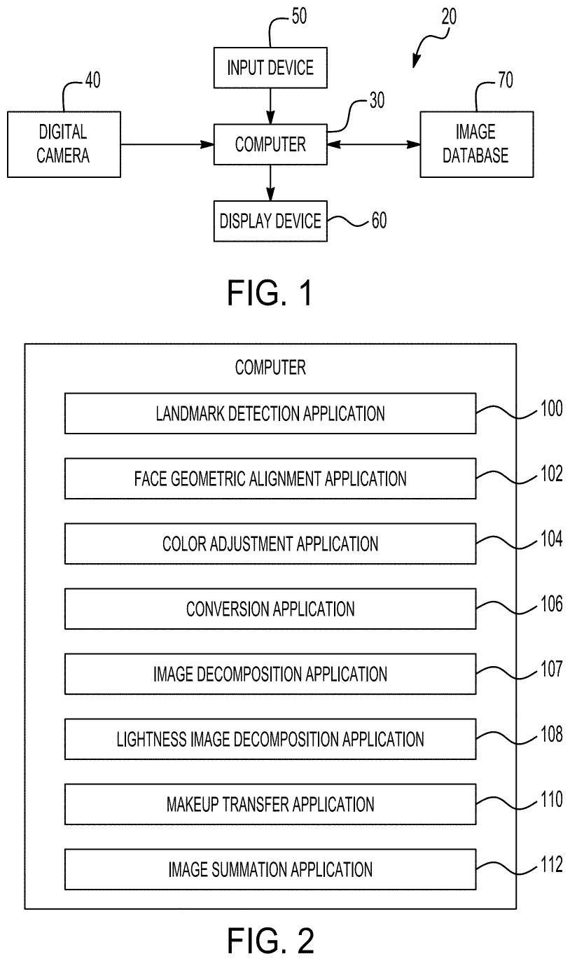

Referring to FIG. 1, a facial image makeup transfer system 20 is provided. The facial image makeup transfer system 20 includes a computer 30, a digital camera 40, an input device 50, a display device 60, and an image database 70.

Referring to FIGS. 1 and 2, the computer 30 is operably coupled to the digital camera 40, the input device 50, the display device 60, and image database 70. The computer 30 includes a landmark detection application 100, a face geometric alignment application 102, a color adjustment application 104, a conversion application 106, an image decomposition application 107, a lightness image decomposition application 108, a makeup transfer application 110, and an image summation application 112.

Before providing a detailed explanation of the computer 30, a high level overview of the operation of the computer 30 will be provided. The computer 30 utilizes two images as input, one with the client whose facial makeup will be transferred (known as reference facial image) and the other with the client whose face will receive the makeup (known as the target facial image). Initially, the position of the two faces is determined using a landmark detection application 100 which encloses each face by a bounding box that provides the spatial coordinates of the client's face in the 2D image. The landmark detection application 100 generates landmarks around different facial components in both images. Having access to the coordinates of each facial element received from the landmark detection application 100 for both the images, the face in the reference facial image is geometrically aligned/warped utilizing the face geometric alignment application 102 such that its geometry fits that of the client face in the target facial image. Thereafter, the color values representing the client face in the reference facial image are smoothly transferred to the corresponding ones in the target facial image in a pixel-wise fashion utilizing the makeup transfer application 110.

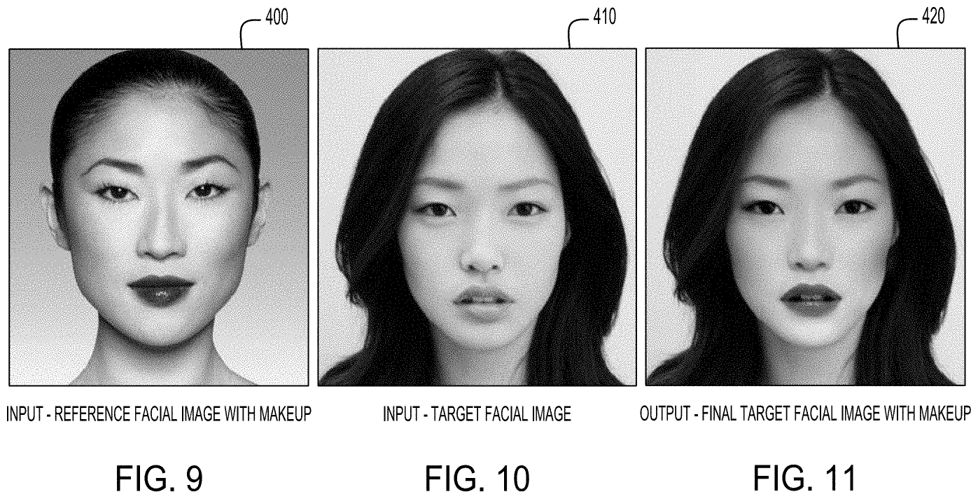

In an exemplary embodiment, referring to FIGS. 9-11, the computer 30 utilizes a reference facial image 400 having a desired makeup therein and a target facial image 410 of a client and to generate a final target facial image 420 of the client having the desired makeup therein.

The digital camera 40 is provided to generate the target facial image of the client and to transfer the target facial image to the computer 30.

The input device 50 is provided to receive client selections for selecting a desired reference facial image having desired makeup therein from a plurality of reference facial images that are displayed on the display device 60.

The display device 16 is provided to display images in response to display instructions received from the computer 30.

The image database 70 is provided to store a plurality of reference facial images and target facial images therein.

An advantage of the facial image makeup transfer system 20 is that the system 20 utilizes a color adjustment application 104 that performs a linear color transformation of a reference facial skin image (generated from the reference facial image) prior to decomposing the images into a second color space such that each channel of the reference facial skin image is uniformly scaled to approach the corresponding channel of the target facial skin image in order to cancel a scaling factor that is applied on the reference facial image due to different lighting conditions in which the reference facial image was captured.

For purposes of understanding, a few technical terms used herein will now be explained.

The term “geometrically aligning” means warping a first image having a first plurality of landmarks therein such that a resulting aligned image has a pixel-to-pixel correspondence to a second image having a second plurality of landmarks therein. In other words, for each pixel in the resulting aligned image has a corresponding pixel at an identical pixel location in the second image.

A “conversion application” is an application that converts an image from a first color space to a second color space.

A “color space” is a specific organization of colors. An exemplary first color space is a RGB (Red-Green-Blue) color space and an exemplary second color space is a CIELAB color space. The CIELAB color space is effective to separate between lightness and color components of the image. CIELAB color space is composed of three channels L, a, b, wherein L is a primary lightness channel image or layer and a and b are color channel images or layers. The primary lightness channel image (L) is decomposed into large lightness channel image (s) which holds the face structure information and a detail lightness channel image (d) which holds the skin details information. The decomposing is performed by applying the edge-preserving Weighted Least Square (WLS) operator on the primary lightness channel image L, to obtain the large lightness channel image (s). Then, the large lightness channel image (s) is subtracted from the primary lightness channel image (L) to obtain the detail channel image (d) as shown in the following equation:

d=L−s

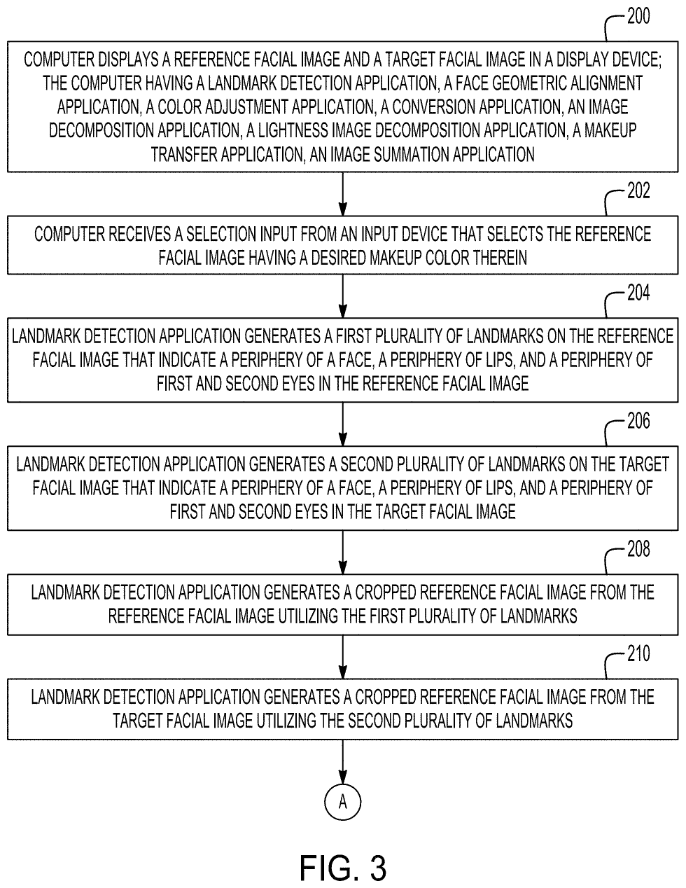

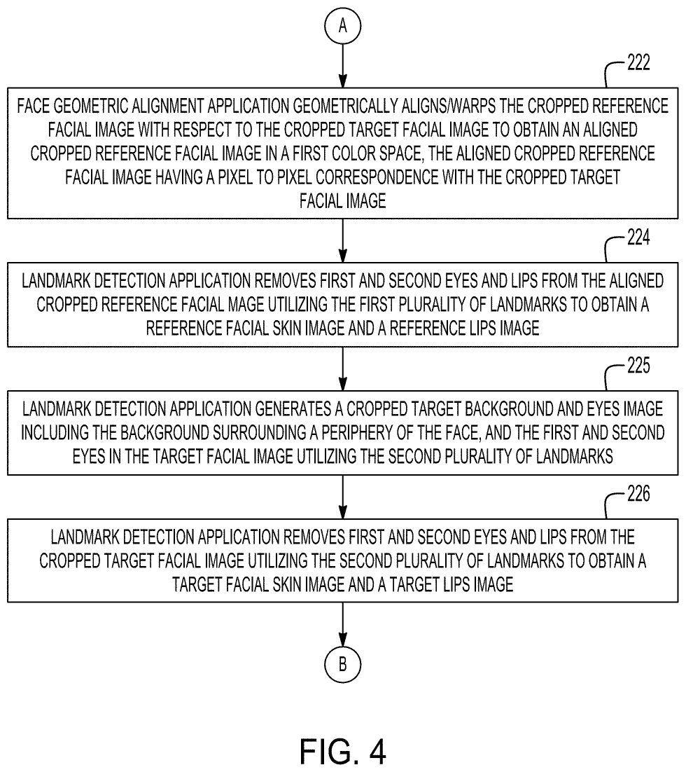

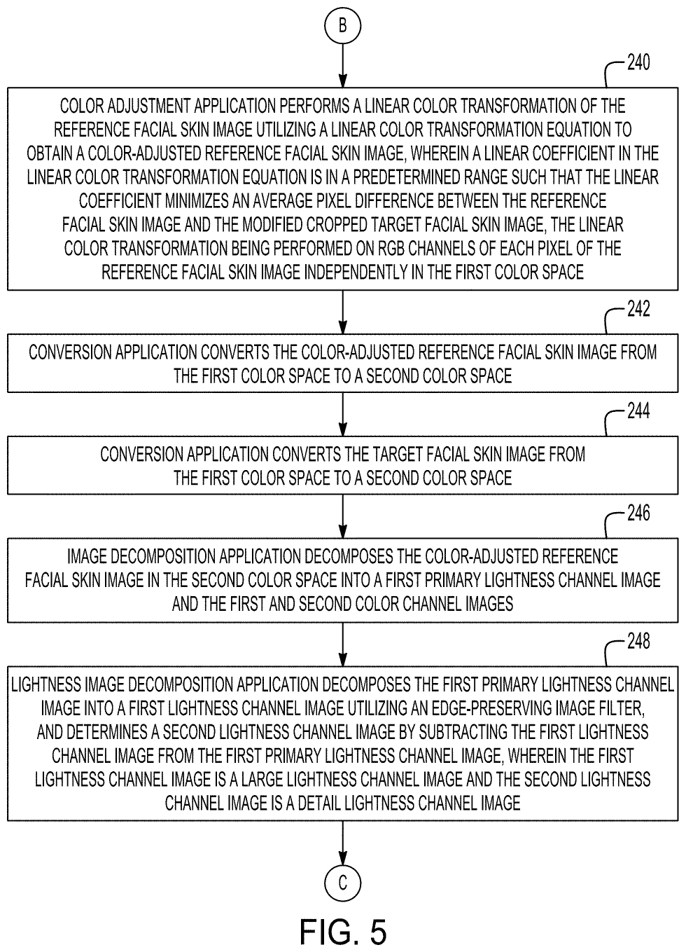

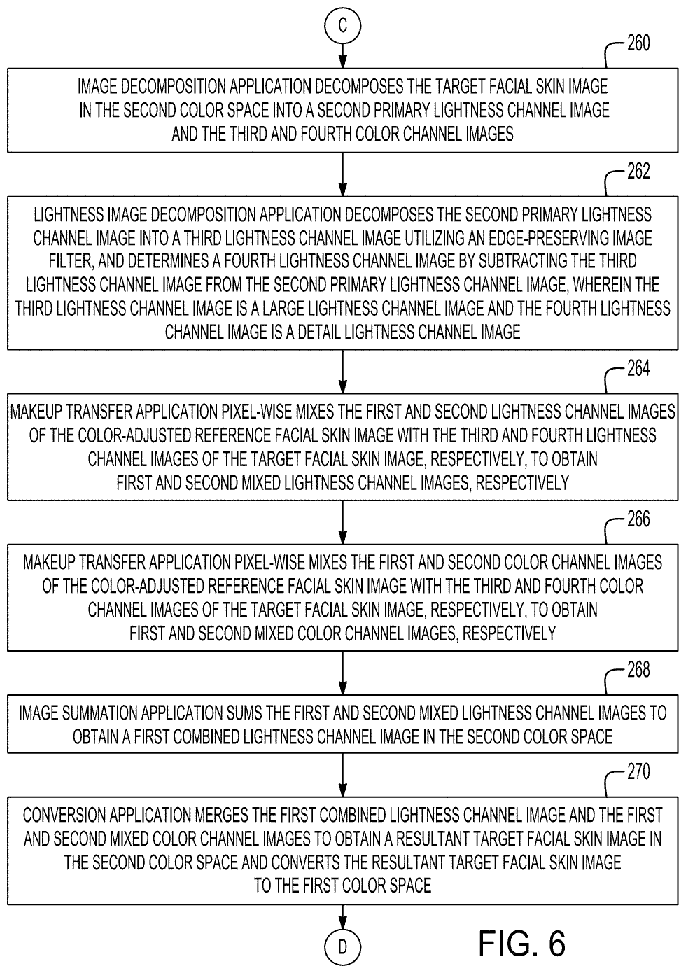

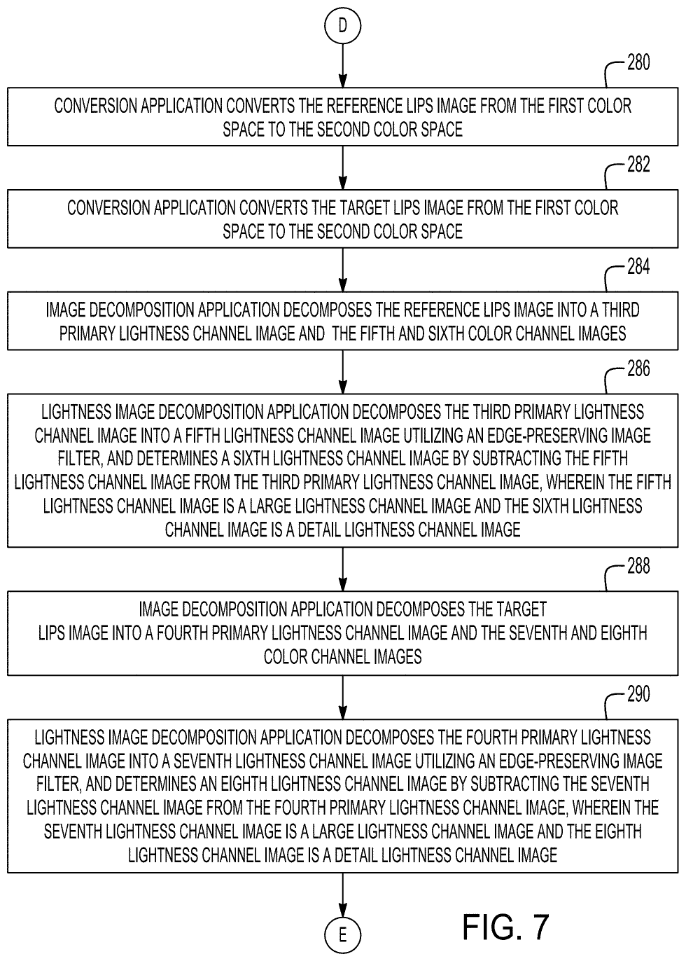

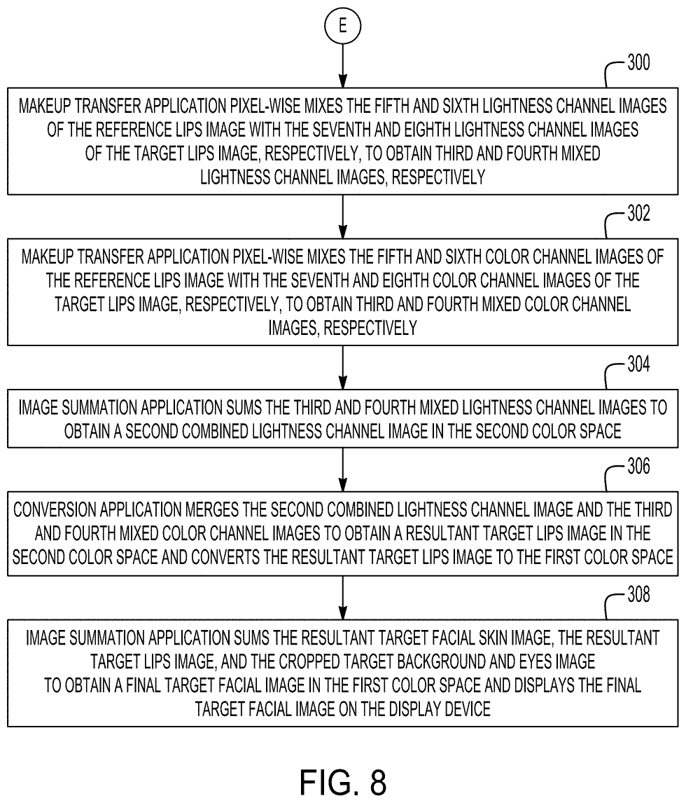

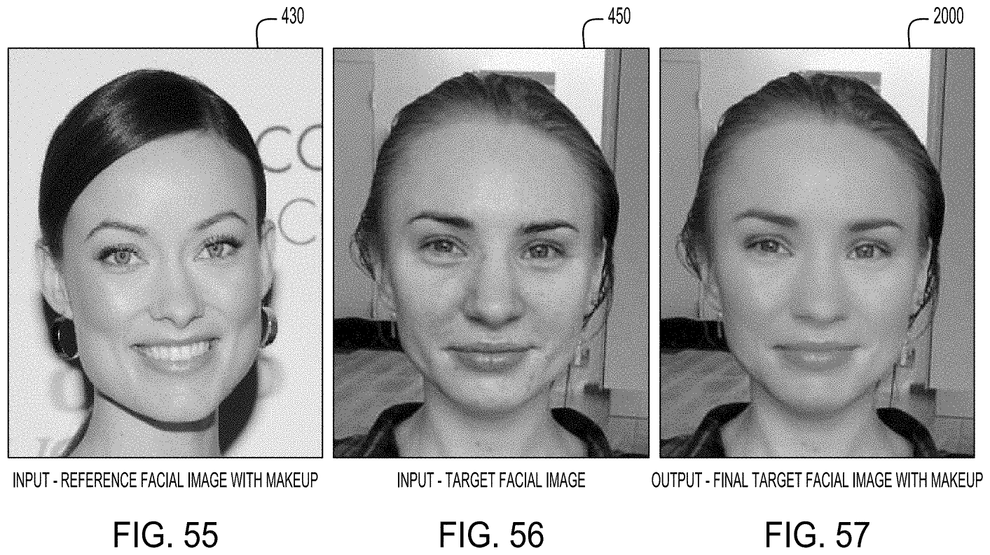

Referring to FIGS. 3-8 and 55-57, a flowchart of a method for generating a final target facial image 2000 (shown in FIG. 57) having a desired makeup thereon based on a reference facial image 430 (shown in FIGS. 12 and 55) having the desired makeup thereon and a target facial image 450 (shown in FIGS. 14 and 56) of a client, utilizing the facial image makeup transfer system 20 will now be explained.

At step 200, the computer 30 displays a reference facial image 430 (shown in FIG. 12) and a target facial image 450 (shown in FIG. 14) on a display device 60. The computer 30 has a landmark detection application 100, a face geometric alignment application 102, a color adjustment application 104, a conversion application 106, an image decomposition application 107, a lightness image decomposition application 108, a makeup transfer application 110, and an image summation application 112. After step 200, the method advances to step 202.

At step 202, the computer 30 receives a selection input from an input device 50 that selects the reference facial image 430 having a desired makeup color therein. After step 202, the method advances to step 204.

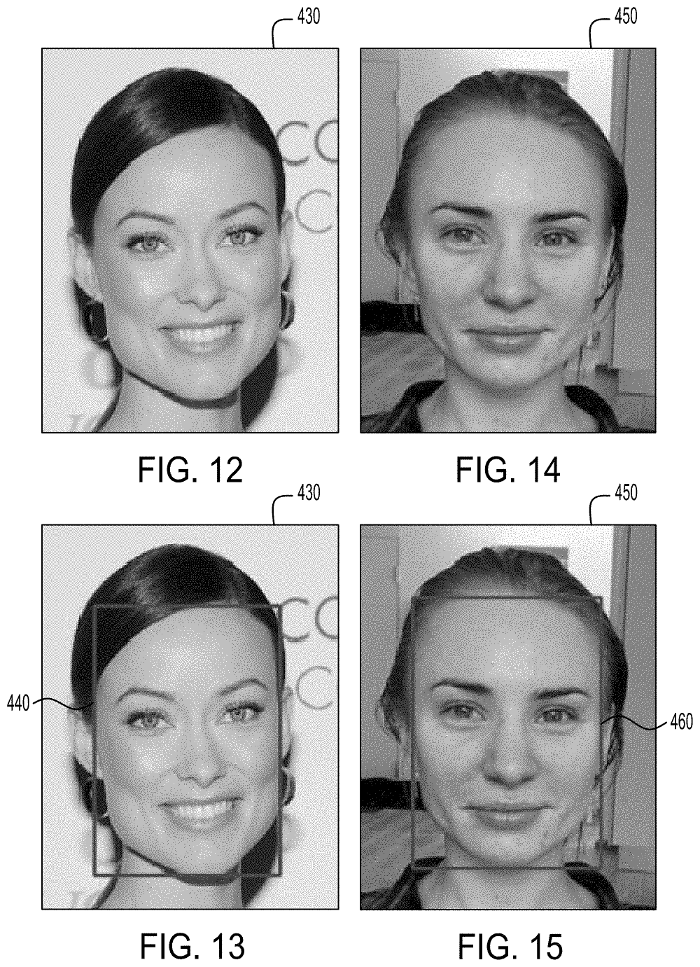

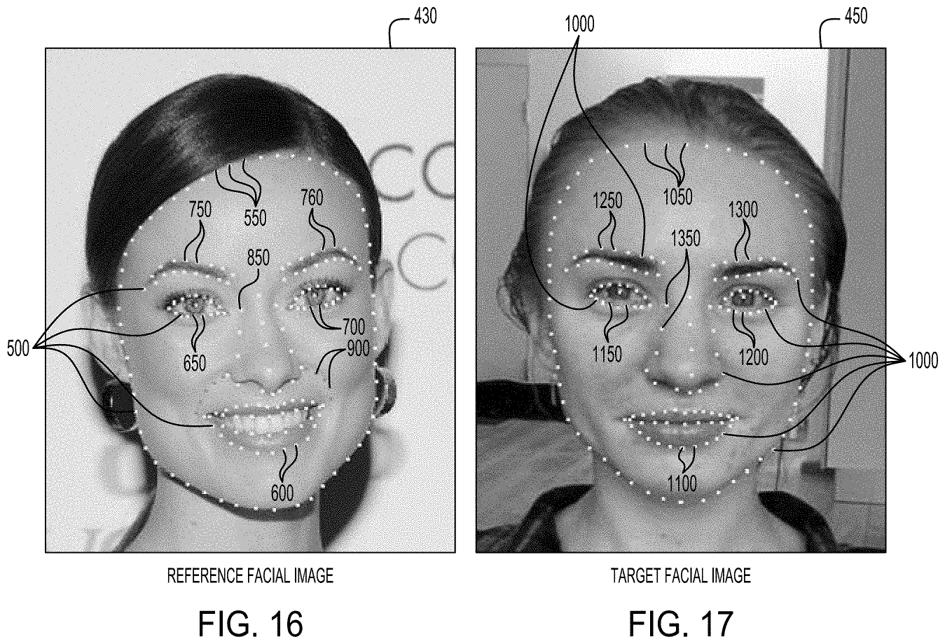

At step 204, the landmark detection application 100 generates a first plurality of landmarks 500 (shown in FIG. 16) on the reference facial image 430 that indicate a periphery of a face, a periphery of lips, and a periphery of first and second eyes in the reference facial image 430. In an exemplary embodiment, referring to FIGS. 12, 13 and 16, the first plurality of landmarks 500 includes facial boundary landmarks 550, lips boundary landmarks 600, first eye boundary landmarks 650, second eye boundary landmarks 700, first eyebrow landmarks 750, second eyebrow landmarks 800, nose boundary landmarks 850, and cheek landmarks 900. After step 204, the method advances to step 206.

At step 206, the landmark detection application 100 generates a second plurality of landmarks 1000 (shown in FIG. 17) on the target facial image 450 that indicate a periphery of a face, a periphery of lips, and a periphery of first and second eyes in the target facial image 450. In an exemplary embodiment, referring to FIGS. 14, 15 and 17, the second plurality of landmarks 1000 includes facial boundary landmarks 1050, lips boundary landmarks 1100, first eye boundary landmarks 1150, second eye boundary landmarks 1200, first eyebrow landmarks 1250, second eyebrow landmarks 1300, and nose boundary landmarks 1350. After step 206, the method advances to step 208.

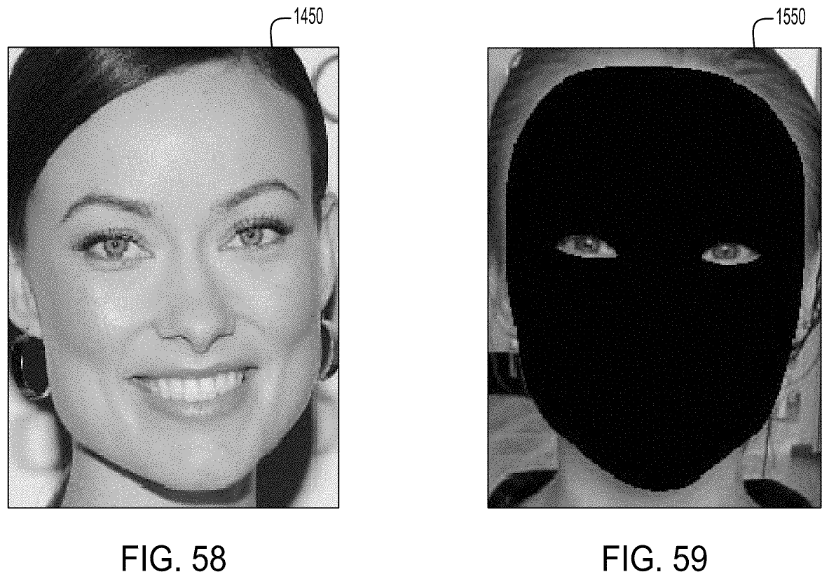

At step 208, the landmark detection application 100 generates a cropped reference facial image 1450 (shown in FIG. 58) from the reference facial image 430 utilizing the first plurality of landmarks 500. After step 208, the method advances to step 210.

At step 210, the landmark detection application 100 generates a cropped target facial image 1560 (shown in FIG. 21) from the target facial image 450 (shown in FIG. 14) utilizing the second plurality of landmarks 1000. After step 210, the method advances to step 222.

At step 222, the face geometric alignment application 102 geometrically aligns/warps the cropped reference facial image 1450 with respect to the cropped target facial image 1560 (shown in FIG. 21) to obtain an aligned cropped reference facial image 1500 (shown in FIG. 18) in a first color space. The aligned cropped reference facial image 1500 has a pixel to pixel correspondence with the cropped target facial image 1560. After step 222, the method advances to step 224.

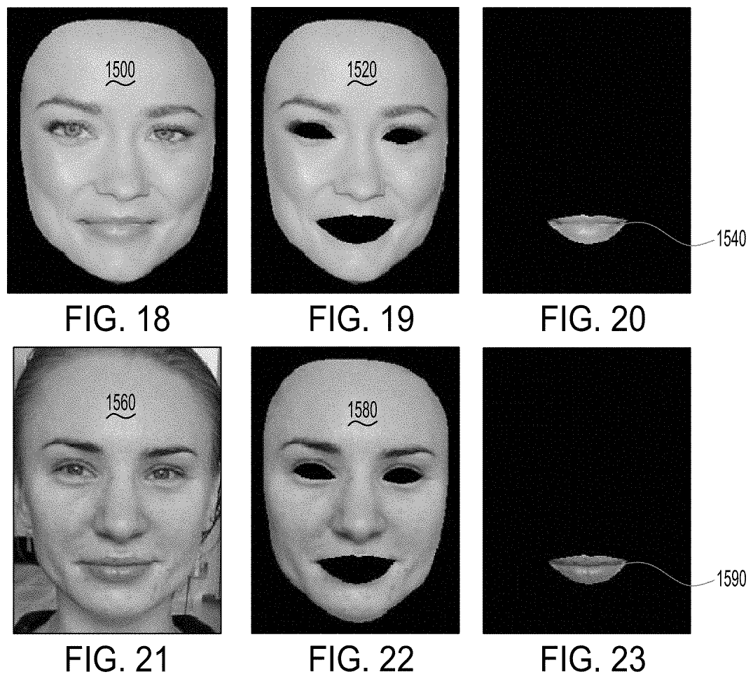

At step 224, the landmark detection application 100 removes first and second eyes and lips from the aligned cropped reference facial image 1500 (shown in FIG, 18) utilizing the first plurality of landmarks 500 to obtain a reference facial skin image 1520 (shown in FIG. 19) and a reference lips image 1540 (shown in FIG. 20). After step 224, the method advances to step 225.

At step 225, the landmark detection application 100 generates a cropped target background and eyes image 1550 (shown in FIG. 59) including the background surrounding a periphery of the face, and first and second eyes in the target facial image 450 utilizing the second plurality of landmarks 1000. After step 225, the method advances to step 226.

At step 226, the landmark detection application 100 removes first and second eyes and lips from the cropped target facial image 1560 (shown in FIG. 21) utilizing the second plurality of landmarks 1000 to obtain a target facial skin image 1580 (shown in FIG. 22) and a target lips image 1590 (shown in FIG. 23). After step 226, the method advances to step 240.

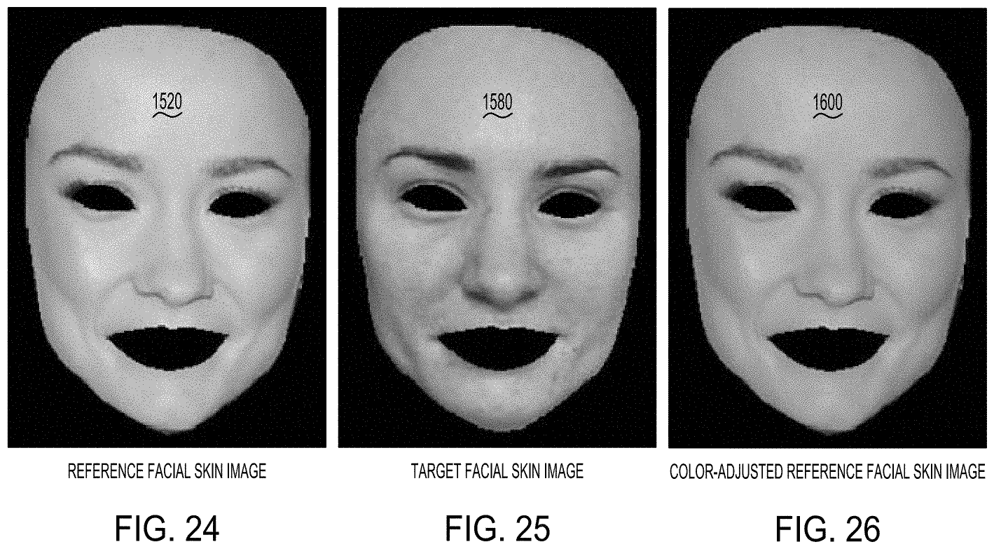

At step 240, the color adjustment application 104 performs a linear color transformation of the reference facial skin image 1520 (shown in FIG. 24) utilizing a linear color transformation equation to obtain a color-adjusted reference facial skin image 1600 (shown in FIG. 26), wherein a linear coefficient in the linear color transformation equation is in a predetermined range such that the linear coefficient minimizes an average pixel difference between the reference facial skin image 1520 and the target facial skin image 1580 (shown in FIG. 25). The linear color transformation is performed on RGB channels of each pixel of the reference facial skin image 1520 independently in the first color space.

In an exemplary embodiment, the linear color transformation equation which performs a linear transformation on RGB channels separately is as follows.

$$min ( \frac{{{\sum }_{i}}^{m} {( {I}_{i}^{reference} - {I}_{i}^{target} )}^{2}}{m} )$$

where Iᵢ is the pixel value at index i and m is the number of pixels.

As can be seen in the above formula, the objective is to minimize the average of pixel difference values between the reference facial skin image 1520 and the target facial skin image 1580.

To minimize the above objective function, the following solution is employed, where at each iteration the reference facial image is linearly transformed.

$${I}^{reference} = {I}^{reference} \times \frac{n}{100} wheren ∈ [ 11000 ]$$

At each iteration with the step size of one, a number from the predefined range (e.g., 1 to 1000) is selected. That number is then divided by 100 to create a scaling factor used to scale the reference facial skin image 1520 to create a new scaled reference facial skin image. Then the mean difference of the new scaled reference facial skin image with the target facial skin image 1580 is recomputed and saved to compare against the next iterations mean difference values. Once all of the iterations over the entire predefined range are completed, all possible mean difference values have been compared against each other and the one scaling factor that yielded the smallest mean difference value would be used as the final scaling factor to scale the reference facial skin image 1520.

After step 240, the method advances to step 242.

At step 242, the conversion application 106 converts the color-adjusted reference facial skin image 1600 (shown in FIG. 26) from the first color space to a second color space. After step 242, the method advances to step 244.

At step 244, the conversion application 106 converts the target facial skin image 1580 (shown in FIG. 22) from the first color space to the second color space. After step 244, the method advances to step 246.

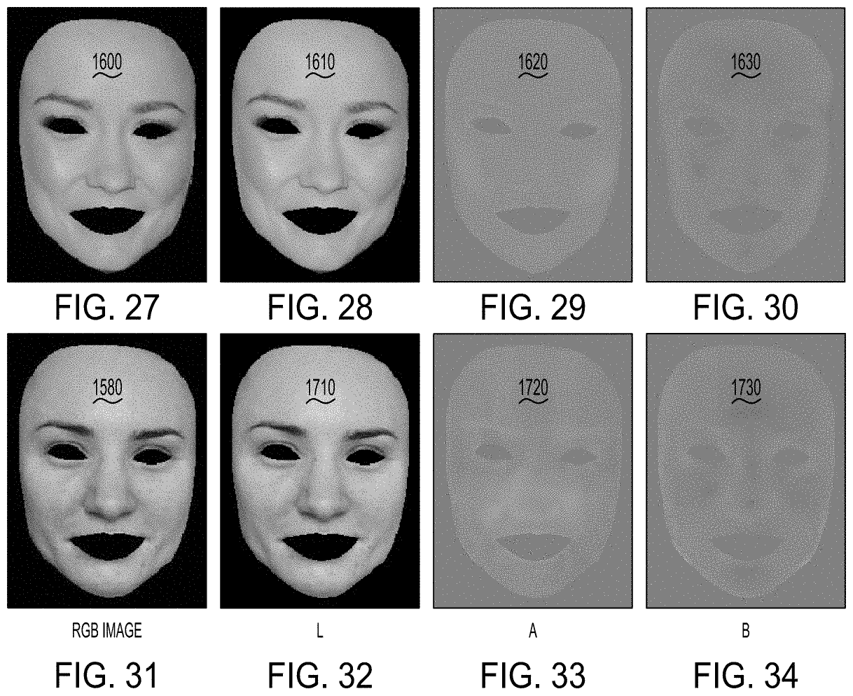

At step 246, the image decomposition application 107 decomposes the color-adjusted reference facial skin image 1600 (shown in FIG. 27) in the second color space into a first primary lightness channel image 1610 (shown in FIG. 28) and the first and second color channel images 1620, 1630 (shown in FIGS. 29, 30 respectively). After step 246, the method advances to step 248.

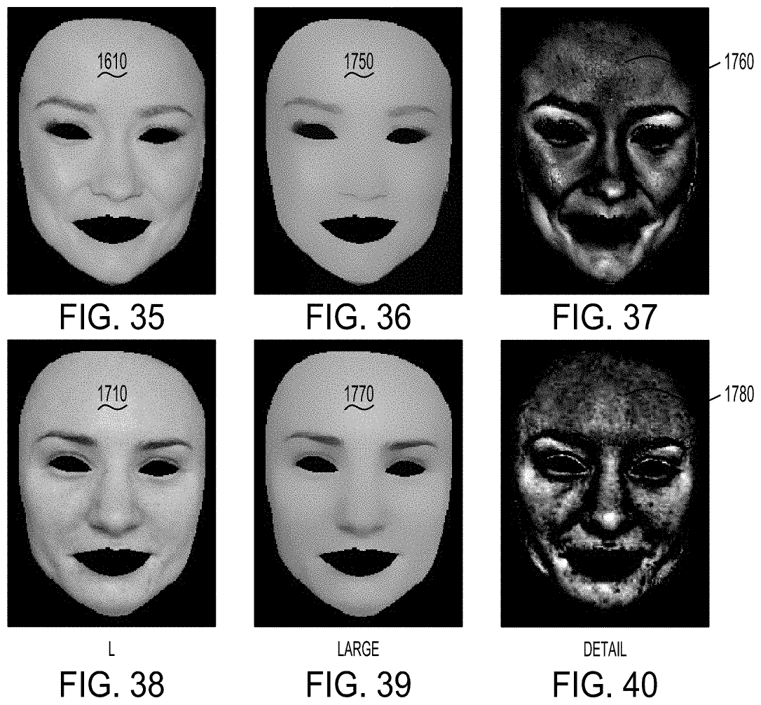

At step 248, the lightness image decomposition application 108 further decomposes the first primary lightness channel image 1610 (shown in FIG. 35) into a first lightness channel image 1750 (shown in FIG. 36) utilizing an edge-preserving image filter, and determines a second lightness channel image 1760 (shown in FIG. 37) by subtracting the first lightness channel image 1750 from the first primary lightness channel image 1610, wherein the first lightness channel image 1750 is a large lightness channel image and the second lightness channel image 1760 is a detail lightness channel image. After step 248, the method advances to step 260.

At step 260, the image decomposition application 107 decomposes the target facial skin image 1580 (shown in FIG. 31) in the second color space into a second primary lightness channel image 1710 (shown in FIG. 32) and the third and fourth color channel images 1720, 1730 (shown in FIGS. 33, 34 respectively). After step 260, the method advances to step 262.

At step 262, the lightness image decomposition application 108 further decomposes the second primary lightness channel image 1710 (shown in FIG. 38) into a third lightness channel image 1770 (shown in FIG. 39) utilizing an edge-preserving image filter, and determines a fourth lightness channel image 1780 (shown in FIG. 40) by subtracting the third lightness channel image 1770 from the second primary lightness channel image 1710, wherein the third lightness channel image 1770 is a large lightness channel image and the fourth lightness channel image 1780 is a detail lightness channel image. After step 262, the method advances to step 264.

At step 264, the makeup transfer application 110 pixel-wise mixes the first and second lightness channel images 1750, 1760 (shown in FIGS. 36, 37 respectively) of the color-adjusted reference facial skin image 1600 (shown in FIG. 27) with the third and fourth lightness channel images 1770, 1780 (shown in FIGS. 39, 40 respectively) of the target facial skin image 1580 (shown in FIG. 31), respectively, to obtain first and second mixed lightness channel images, respectively.

In an exemplary embodiment, the first mixed lightness channel image is determined utilizing the following equation: first mixed lightness channel image=A×(first lightness channel image)+B×(third lightness channel image), where A>=0, B>=0, A+B=1.

Further, the second mixed lightness channel image is determined utilizing the following equation: second mixed lightness channel image=A×(second lightness channel image)+B×(fourth lightness channel image), where A>=0, B>=0, A+B=1.

After step 264, the method advances to step 266.

At step 266, the makeup transfer application 110 pixel-wise mixes the first and second color channel images 1620, 1630 (shown in FIGS. 29, 30 respectively) of the color-adjusted reference facial skin image 1600 (shown in FIG. 27) with the third and fourth color channel images 1720, 1730 (shown in FIGS. 33 and 34 respectively) of the target facial skin image 1580 (shown in FIG. 31), respectively, to obtain first and second mixed color channel images, respectively.

In an exemplary embodiment, the first mixed color channel image is determined utilizing the following equation: first mixed color channel image=α×(first color channel image)+(1−α)×(third color channel image), where 0<=α<=1.

Further, the second mixed color channel image is determined utilizing the following equation: second mixed color channel image=α×(second color channel image)+(1−α)×(fourth color channel image), where 0<=α<=1.

After step 266, the method advances to step 268.

At step 268, the image summation application 112 sums the first and second mixed lightness channel images to obtain a first combined lightness channel image in the second color space. After step 268, the method advances to step 270.

At step 270, the conversion application 106 merges the first combined lightness channel image and the first and second mixed color channel images to obtain a resultant target facial skin image in the second color space and converts the resultant target facial skin image to the first color space. After step 270, the method advances to step 280.

At step 280, the conversion application 106 converts the reference lips image 1540 (shown in FIG. 20) from the first color space to the second color space. After step 280, the method advances to step 282.

At step 282, the conversion application 106 converts the target lips image 1590 (shown in FIG. 45) from the first color space to the second color space. After step 282, the method advances to step 284.

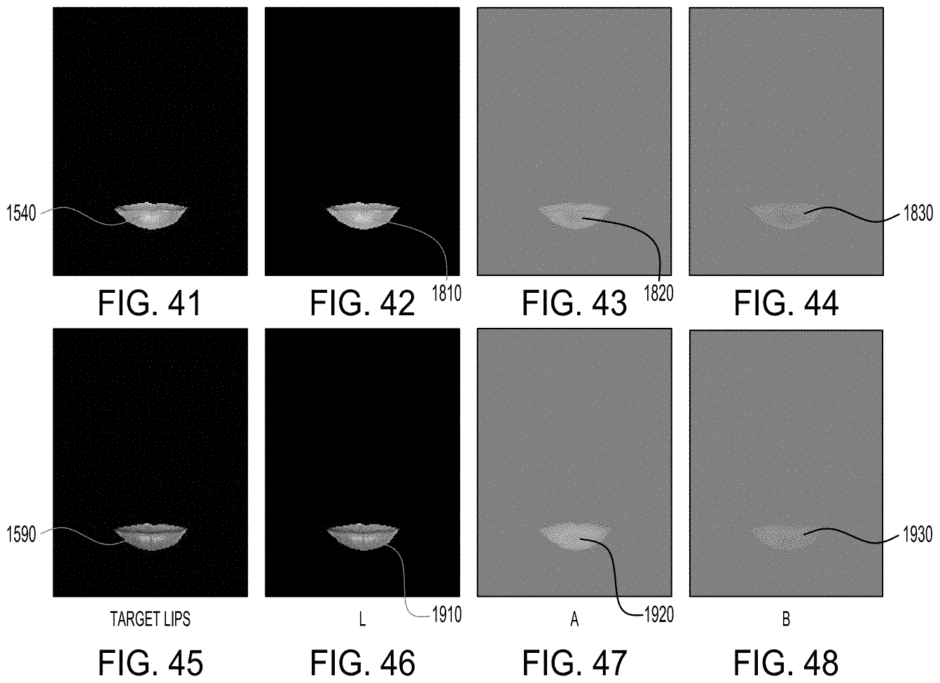

At step 284, the image decomposition application 107 decomposes the reference lips image 1540 (shown in FIG. 41) into a third primary lightness channel image 1810 (shown in FIG. 42) and the fifth and sixth color channel images 1820, 1830 (shown in FIGS. 43, 44 respectively). After step 284, the method advances to step 286.

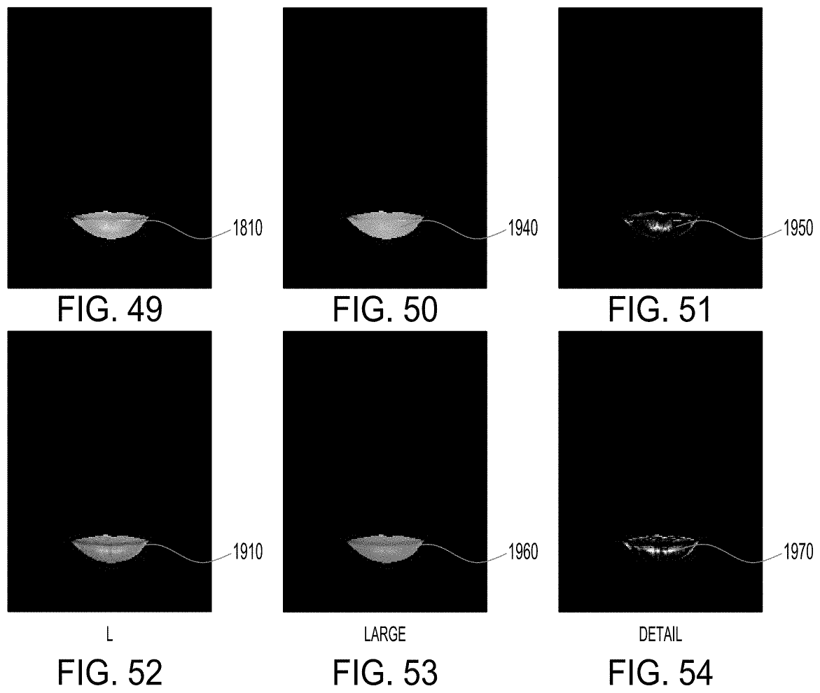

At step 286, the lightness image decomposition application 108 further decomposes the third primary lightness channel image 1810 (shown in FIG. 49) into a fifth lightness channel image 1940 (shown in FIG. 50) utilizing an edge-preserving image filter, and determines a sixth lightness channel image 1950 (shown in FIG. 51) by subtracting the fifth lightness channel image 1940 from the third primary lightness channel image 1810, wherein the fifth lightness channel image 1940 is a large lightness channel image and the sixth lightness channel image 1950 is a detail lightness channel image. After step 286, the method advances to step 288.

At step 288, the image decomposition application 107 decomposes the target lips image 1590 into a fourth primary lightness channel image 1910 (shown in FIG. 46) and the seventh and eighth color channel images 1920, 1930 (shown in FIGS. 47, 48 respectively). After step 288, the method advances to step 290.

At step 290, the lightness image decomposition application 108 further decomposes the fourth primary lightness channel image 1910 (shown in FIG. 52) into a seventh lightness channel image 1960 (shown in FIG. 53) utilizing an edge-preserving image filter, and determines an eighth lightness channel image 1970 (shown in FIG. 54) by subtracting the seventh lightness channel image 1960 from the fourth primary lightness channel image 1910, wherein the seventh lightness channel image 1960 is a large lightness channel image and the eighth lightness channel image 1970 is a detail lightness channel image. After step 290, the method advances to step 300.

At step 300, the makeup transfer application 110 pixel-wise mixes the fifth and sixth lightness channel images 1940, 1950 (shown in FIGS. 50, 51 respectively) of the reference lips image 1540 with the seventh and eighth lightness channel images 1960, 1970 (shown in FIGS. 53 and 54 respectively) of the target lips image 1590, respectively, to obtain third and fourth mixed lightness channel images, respectively.

In an exemplary embodiment, the third mixed lightness channel image is determined utilizing the following equation: third mixed lightness channel image=A×(fifth lightness channel image)+B×(seventh lightness channel image), where A>=0, B>=0, A+B=1.

Further, the fourth mixed lightness channel image is determined utilizing the following equation: fourth mixed lightness channel image=A×(sixth lightness channel image)+B×(eighth lightness channel image), where A>=0, B>=0, A+B=1.

After step 300, the method advances to step 302.

At step 302, the makeup transfer application 110 pixel-wise mixes the fifth and sixth color channel images 1820, 1830 (shown in FIGS. 43 and 44 respectively) of the reference lips image 1540 with the seventh and eighth color channel images 1920, 1930 (shown in FIGS. 47 and 48 respectively) of the target lips image 1590, respectively, to obtain third and fourth mixed color channel images, respectively.

In an exemplary embodiment, the third mixed color channel image is determined utilizing the following equation: third mixed color channel image=α×(fifth color channel image)+(1−α)×(seventh color channel image), where 0<=α<=1.

Further, the fourth mixed color channel image is determined utilizing the following equation: fourth mixed color channel image=α×(sixth color channel image)+(1−α)×(eighth color channel image), where 0<=α<=1.

After step 302, the method advances to step 304.

At step 304, the image summation application 112 sums the third and fourth mixed lightness channel images to obtain a second combined lightness channel image in the second color space. After step 304, the method advances to step 306.

At step 306, the conversion application 106 merges the second combined lightness channel image and the third and fourth mixed color channel images to obtain a resultant target lips image in the second color space and converts the resultant target lips image to the first color space. After step 306, the method advances to step 308.

At step 308, the image summation application 112 sums the resultant target facial skin image, the resultant target lips image, the cropped target background and eyes image 1550 to obtain a final target facial image 2000 (shown in FIG. 57) in the first color space and displays the final target facial image 2000 on the display device 60.

While the claimed invention has been described in detail in connection with only a limited number of embodiments, it should be readily understood that the invention is not limited to such disclosed embodiments. Rather, the claimed invention can be modified to incorporate any number of variations, alterations, substitutions or equivalent arrangements not heretofore described, but which are commensurate with the spirit and scope of the invention. Additionally, while various embodiments of the claimed invention have been described, it is to be understood that aspects of the invention may include only some of the described embodiments. Accordingly, the claimed invention is not to be seen as limited by the foregoing description.

What is claimed is:

1. A facial image makeup transfer system, comprising:
a display device;
a computer operably coupled to the display device, the computer having a color adjustment application, a conversion application, an image decomposition application, a lightness image decomposition application, a makeup transfer application, and an image summation application;
the color adjustment application performing a linear color transformation of a reference facial skin image utilizing a linear color transformation equation to obtain a color-adjusted reference facial skin image;
the conversion application converting the color-adjusted reference facial skin image from the first color space to a second color space;
the conversion application converting a target facial skin image from the first color space to the second color space;
the image decomposition application decomposing the color-adjusted reference facial skin image in the second color space into a first primary lightness channel image and first and second color channel images;
the lightness image decomposition application decomposing the first primary lightness channel image into first and second lightness channel images;
the image decomposition application decomposing the target facial skin image in the second color space into a second primary lightness channel image and third and fourth color channel images;
the lightness image decomposition application decomposing the second primary lightness channel image into third and fourth lightness channel images;
the makeup transfer application that pixel-wise mixes the first and second lightness channel images of the color-adjusted reference facial skin image with the third and fourth lightness channel images of the target facial skin image, respectively, to obtain first and second mixed lightness channel images, respectively;
the makeup transfer application pixel-wise mixes the first and second color channel images of the color-adjusted reference facial skin image with the third and fourth color channel images of the target facial skin image, respectively, to obtain first and second mixed color channel images, respectively;
the image summation application sums the first and second mixed lightness channel images to obtain a first combined lightness channel image; and
the conversion application merges the first combined lightness channel image and the first and second mixed color channel images to obtain a resultant target facial skin image in the second color space and converts the resultant target facial skin image to the first color space.

2. The facial image makeup transfer system of claim 1, wherein a linear coefficient in the linear color transformation equation is in a predetermined range such that the linear coefficient minimizes an average pixel difference between the reference facial skin image and the target facial skin image, the linear color transformation being performed on RGB channels of each pixel of the reference facial skin image independently in the first color space.

3. The facial image makeup transfer system of claim 1, wherein the first color space is a Red-Green-Blue color space and the second color space is a CIE-Lab color space.

4. The facial image makeup transfer system of claim 1, wherein:
the computer instructing the display device to display a reference facial image and a target facial image, the computer further having a landmark detection application and a face geometric alignment application;
the landmark detection application generating a cropped reference facial image from the reference facial image;
the landmark detection application generating a cropped target facial image from the target facial image;
the face geometric alignment application geometrically aligning the cropped reference facial image with respect to the cropped target facial image to obtain an aligned cropped reference facial image in a first color space, the aligned cropped reference facial image having a pixel to pixel correspondence with the cropped target facial image;
the landmark detection application removing first and second eyes and lips from the aligned cropped reference facial image to obtain the reference facial skin image and a reference lips image; and
the landmark detection application removing first and second eyes and lips and from the cropped target facial image to obtain the target facial skin image and a target lips image.

5. The facial image makeup transfer system of claim 4, wherein:
the conversion application converting the reference lips image from the first color space to the second color space;
the conversion application converting the target lips image from the first color space to the second color space;
the image decomposition application decomposing the reference lips image in the second color space into a third primary lightness channel image and fifth and sixth color channel images;
the lightness image decomposition application decomposing the third primary lightness channel image into fifth and sixth lightness channel images;
the image decomposition application decomposing the target lips image in the second color space into a fourth primary lightness channel image and seventh and eighth color channel images;
the lightness image decomposition application decomposing the fourth primary lightness channel image into seventh and eighth lightness channel images;
the makeup transfer application pixel-wise mixes the fifth and sixth lightness channel images of the reference lips image with the seventh and eighth lightness channel images of the target lips image, respectively, to obtain third and fourth mixed lightness channel images, respectively; the makeup transfer application pixel-wise mixes the fifth and sixth color channel images of the reference lips image with the seventh and eighth color channel images of the target lips image, respectively, to obtain third and fourth mixed color channel images, respectively;
the image summation application sums the third and fourth mixed lightness channel images to obtain a second combined lightness channel image in the second color space;
the conversion application merges the second combined lightness channel image and the third and fourth mixed color channel images to obtain a resultant target lips image in the second color space and converts the resultant target lips image to the first color space.

6. The facial image makeup transfer system of claim 5, wherein:
the image summation application sums the resultant target facial skin image and the resultant target lips image to obtain a final target facial image in the first color space.

7. The facial image makeup transfer system of claim 6, further comprising:
an input device operably coupled to the computer; and
the computer receiving a selection input from the input device selecting the reference facial image having a desired makeup color therein.

8. The facial image makeup transfer system of claim 7, wherein:
the computer further displaying the target facial image and the final target facial image on the display device.

9. The facial image makeup transfer system of claim 5, wherein:
the landmark detection application generating a first plurality of landmarks on the reference facial image that indicate a periphery of a face, a periphery of the lips, and a periphery of the first and second eyes in the reference facial image; and
the landmark detection application generating the second plurality of landmarks on the target facial image that indicate a periphery of a face, a periphery of the lips, and a periphery of the first and second eyes in the target facial image.

10. The facial image makeup transfer system of claim 9, wherein:
the landmark detection application generating the cropped reference facial image from the reference facial image utilizing the first plurality of landmarks; and
the landmark detection application generating the cropped target facial image from the target facial image utilizing the second plurality of landmarks.

11. The facial image makeup transfer system of claim 5, wherein:
the lightness image decomposition application decomposing the first primary lightness channel image into the first lightness channel image utilizing an edge-preserving image filter, and determining the second lightness channel image by subtracting the first lightness channel image from the first primary lightness channel image, and the first lightness channel image is a large lightness channel image and the second lightness channel image is a detail lightness channel image.

12. The facial image makeup transfer system of claim 11, wherein:
the lightness image decomposition application decomposing the second primary lightness channel image into the third lightness channel image utilizing the edge-preserving image filter, and determining the fourth lightness channel image by subtracting the third lightness channel image from the second primary lightness channel image, and the third lightness channel image is a large lightness channel image and the fourth lightness channel image is a detail lightness channel image.

13. The facial image makeup transfer system of claim 12, wherein:
the lightness image decomposition application decomposing the third primary lightness channel image into the fifth lightness channel image utilizing the edge-preserving image filter, and determining the sixth lightness channel image by subtracting the fifth lightness channel image from the third primary lightness channel image, and the fifth lightness channel image is a large lightness channel image and the sixth lightness channel image is a detail lightness channel image.

14. The facial image makeup transfer system of claim 13, wherein:
the lightness image decomposition application decomposing the fourth primary lightness channel image into the seventh lightness channel image utilizing the edge-preserving image filter, and determining the eighth lightness channel image by subtracting the seventh lightness channel image from the fourth primary lightness channel image, and the seventh lightness channel image is a large lightness channel image and the eighth lightness channel image is a detail lightness channel image.
